(19) United States
(12) Patent Application Publication
(10) Pub. No.: US 2025/0310281 A1
(43) Pub. Date: Oct. 2, 2025

(54) CONTEXTUALIZING CHAT RESPONSES BASED ON CONVERSATION HISTORY

(71) Applicant: Microsoft Technology Licensing, LLC, Redmond, WA (US)

(72) Inventors: Dan RONG, Redmond, WA (US); Payal BAJAJ, Redmond, WA (US); Raunak ANAND, Fremont, CA (US); Joshua Zvi GLATT, Berkeley, CA (US); Joshua James CLAUSMAN, Ames, IA (US); Jingyuan WANG, Redmond, WA (US); Haochen LI, Bellevue, WA (US); Yijia HE, Surrey, British Colombia (CA); Weiming WEN, Bellevue, WA (US); Dong Han WANG, Bellevue, WA (US); Yuan GAO, Bellevue, WA (US); Chongwei RUAN, Redmond, WA (US); Jiajun NIU, Sammamish, WA (US); Patrick XIA, Bellevue, WA (US); Fei TENG, Redmond, WA (US); Bradley Moore ABRAMS; Rahul MEHROTRA, Toronto, Ontario (CA); Haichao YI, Kirkland, WA (US)

(73) Assignee: Microsoft Technology Licensing, LLC, Redmond, WA (US)

(21) Appl. No.: 18/622,551

(22) Filed: Mar. 29, 2024

(51) Int. Cl. H04L 51/02; H04L 51/216

(52) U.S. Cl. CPC H04L 51/02; H04L 51/216

(57) ABSTRACT

Systems and methods for providing a contextual conversation via a chat agent. The chat agent includes or is in communication with an artificial intelligence (AI) language model (LM). In examples, the chat agent leverages the LM and one or more knowledge bases to obtain prior conversation context and/or other contextual details to assist in generating accurate and relevant chat responses to chat inputs received from the user. In some examples, a user profile is built asynchronously based on descriptive elements extracted from prior conversations. In other examples, granular contextual details of prior conversations relevant to the chat input are identified based on a semantic search. Long-term preferences and/or granular contextual details are obtained and provided to the LM with received chat input to generate a personalized chat response for the user.

### BACKGROUND

Computing applications or programs are designed to help users perform various tasks, such as to access and interact with websites and webpages, electronically communicate, generate, compose, edit, and/or manage information, manipulate data, perform visual construction, resource coordination, calculations, etc. Various applications include or are operatively connected to a chat agent that provides a conversational interface for receiving natural language (NL) inputs from an application user, processing the NL inputs, and generating responses to the user inputs as part of a conversation.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for providing a conversational chat agent that tailors chat responses to a user in a conversation. The chat agent includes functionality for receiving natural language (NL) input from the user, interpreting the intent from the NL input, and using prior conversational context related to the user for generating and providing relevant, accurate, and tailored responses. For instance, prior conversation context enriches the interaction between the user and the chat agent by enabling a more nuanced understanding of the user's chat input to generate relevant, accurate, and tailored chat responses. The user's experience is, therefore, enhanced, increasing engagement with the chat agent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example system in which a chat agent is implemented for providing a contextualized conversation according to an aspect;

FIGS. 2A-2D depict a first data flow for providing a contextualized conversation according to an example;

FIGS. 3A and 3B depict a second data flow for providing a contextualized conversation according to an example;

FIG. 4 is an illustration of a chat agent user interface via which a contextualized conversation with a user is implemented according to an example;

FIG. 5 depicts a first method for providing a contextualized conversation according to an example;

FIG. 6 depicts a second method for providing a contextualized conversation according to another example;

FIGS. 7A and 7B depict a third method for providing a contextualized conversation according to another example;

FIGS. 7C and 7D depict a fourth method for providing a contextualized conversation according to another example; and

FIG. 8 is a block diagram illustrating example physical components of a computing device with which aspects of the disclosure may be practiced.

### DETAILED DESCRIPTION

Examples described in this disclosure relate to systems and methods for providing a contextual conversation between a user and an artificial intelligence (AI) language model (LM)-based chat agent. For instance, the chat agent presents an interface where natural language (NL) chat input of a question, statement, etc., is received. In various implementations, the chat agent uses a language model (LM) to generate responses. In such implementations, the chat agent processes the user inputs to extract relevant information and context to understand the user's intent/query. The chat agent then sends a request to the LM, providing the processed user input as input to the model, and receives a response from the LM. The chat agent may perform additional post-processing on the LM response and then provide a processed (chat) response to the user through the conversational interface. According to an aspect of LMs, providing additional context in a request to an LM can improve the quality, relevance, and accuracy of the generated response. Contextual details, such as preferences, constraints, specific examples, and/or scenarios help the LM generate responses that are more aligned with the user's expectations.

With the presently disclosed technology, the chat agent uses an AI LM to generate a chat response to the chat input. In examples, the chat agent obtains and provides prior conversation context to the LM to generate responses that are tailored to the user. In some examples, the prior conversation context is represented as a user profile asynchronously built over time based on descriptive elements extracted from discrete prior conversations with the user. In other examples, the prior conversation context is represented as indexed data of one or more prior conversations in a conversation history data store, where the indexed data is identified as relevant to the chat input. The prior conversation context enables the LM to generate more relevant, accurate, and user-tailored responses. For instance, the prior conversation context allows the LM to better understand the chat input, reducing ambiguity and aiding in comprehending nuances, leading to more focused answers and more accurate responses aligned with user expectations and tailored to identified user preferences and ultimately allowing for personalized and more satisfying interactions between the user and the chat agent.

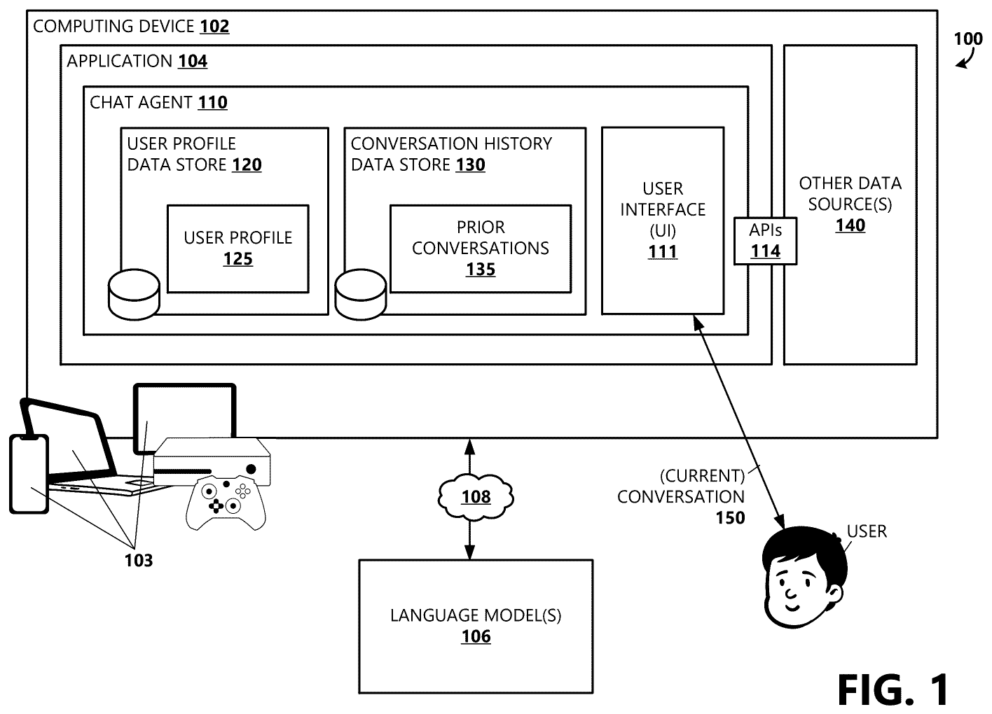

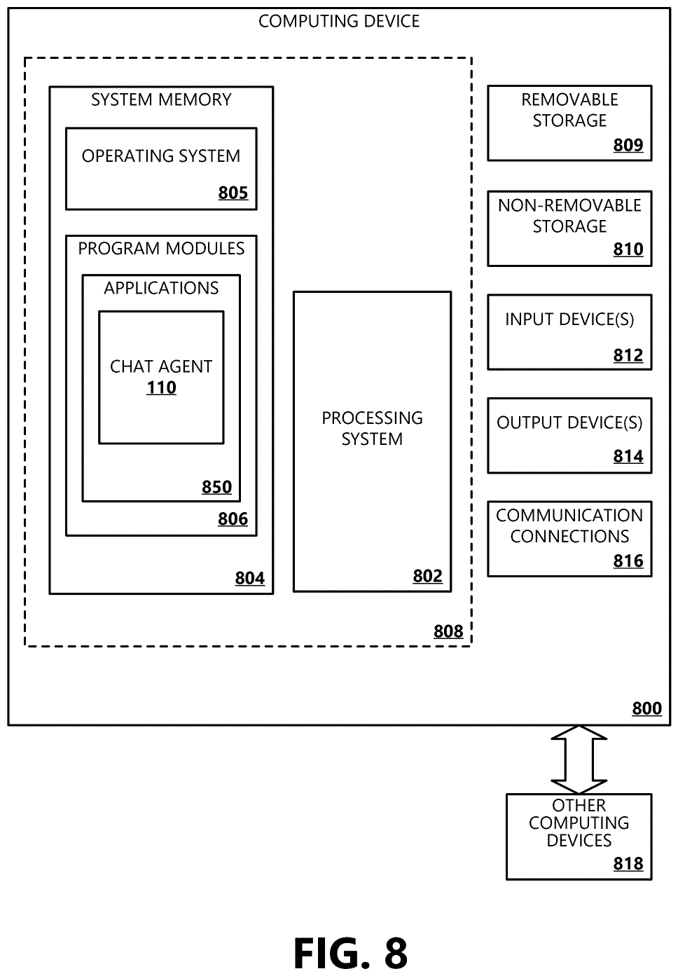

FIG. 1 is a block diagram of a system 100 including a chat agent 110 operative to provide a conversation 150 that is contextualized to a user. That is, responses provided to the user in the conversation 150 are tailored to the user based on context from prior conversations 135. The example system 100, as depicted, is a combination of interdependent components that interact to form an integrated whole. Some components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of processing device(s) comprising such an operating environment is depicted in FIG. 8. In another example, the components of systems disclosed herein are distributed across multiple processing devices. For instance, input may be entered on a user device or client device and information may be processed on or accessed from other devices in a network, such as one or more remote cloud devices or web server devices.

According to an aspect, the system 100 includes a computing device 102 that may take a variety of forms, including, for example, desktop computers, laptops, tablets, smart phones, wearable devices, gaming devices/platforms, virtualized reality devices/platforms (e.g., virtual reality (VR), augmented reality (AR), mixed reality (MR)), etc. The computing device 102 has an operating system that provides a graphical user interface (GUI) that allows users to interact with the computing device 102 via graphical elements, such as application windows (e.g., display areas), buttons, icons, and the like. For example, the graphical elements are displayed on a display screen 103 of the computing device 102 and can be selected and manipulated via user inputs received via a variety of input device types (e.g., keyboard, mouse, stylus, touch, spoken commands, gesture). In further examples, the computing device 102 includes or is communicatively connected to a microphone and/or a speaker via which the computing device 102 receives spoken user input and/or plays audio output, respectively.

In examples, the computing device 102 includes one or more applications (collectively, application 104) for performing various tasks. For instance, a user of the computing device 102 may use an application 104 to access and interact with websites and webpages, electronically communicate, generate, compose, edit, and/or manage information, manipulate data, perform visual construction, resource coordination, calculations, etc. The application 104 has an application user interface (UI) by which the user can view and interact with content and features provided by the application 104. In some examples, the application UI is presented on the display screen 103. In other examples, elements of the application UI are presented are presented audibly to the user via another output device (e.g., the speaker) of the computing device 102. In some examples, the operating environment is a multi-application environment by which the user may view and interact with multiple applications through multiple application UIs.

The chat agent 110 may provide information or assistance to users through NL (e.g., human-like text) conversations. In examples, when the user is authenticated, the user computing device 102 sends a message to the chat agent 110 indicating the authentication of the user. A user may interact with the chat agent 110 in a conversational or natural-language manner, using text, graphics, speech, gestures, etc. As will be described in further detail below, in various examples, the chat agent 110 provides functionality for receiving NL input from the user, interpreting the user's intent, and using prior conversation context for generating and providing a personalized response in a conversation 150 with the user. In some examples, the chat agent 110 is integrated into an operating system of the computing device 102. In other examples, the chat agent 110 is integrated into the application 104, which may be a web browser among other types of applications. For instance, functionality of the chat agent 110 may be embedded in the application's codebase, where user interaction with the chat agent 110 is performed through a UI provided by the application 104. In other examples, the operating system or application 104 communicates with an external chat agent 110 (e.g., a chat agent service). For instance, the chat agent 110 may be hosted by a cloud platform service that hosts chat agents and makes them available to various channels. In examples, the chat agent 110 communicates with the application 104 using application programming interface (APIs) 114 that enables real-time, interactive communication. In examples, the APIs 114 provide a set of predefined rules and protocols that allows the chat agent 110 and the application 104 to communicate and exchange information. The APIs 114 enable the chat agent 110 to make API requests to retrieve data or drive various application actions. The chat agent 110 is operative to construct API requests including required data for retrieving data and/or driving the various application actions. In some examples, the chat agent 110 is further operative to receive and interpret API responses and handle various scenarios based on data returned.

In examples, the chat agent 110 provides a conversational interface in a chat UI 111. The chat UI 111 may be displayed in a frame inside or outside of an operating system UI or application UI. Via the chat UI 111, the chat agent 110 engages in a conversation 150 with a user. In the conversation 150, chat agent 110 provides relevant information, answers questions, offers guidance, troubleshoots issues, directs the user to resources, etc. For instance, in the conversation 150, the chat agent 110 receives a user input (herein referred to as a chat input), processes the chat input, and provides a relevant output (herein referred to as a chat response). In some examples, the conversation 150 includes multiple turns of receiving and processing chat inputs and providing chat responses.

The chat input includes a question, a statement, a request for information, a scenario description, and/or other relevant data (e.g., text, an image, a graphical representation of information, video content, or audio content) that sets a context for the conversation 150 or seeks a specific chat response. According to examples, the term “context” is used to describe information that can inform or influence an interpretation of the intent of the chat input or affect the generated response. Processing the chat input includes analyzing the language, keywords, and/or structure of the chat.

In examples, one or more chat inputs shared by the user in the conversation 150 include contextual details about the user. The contextual details can include factual or subjective information about the user that identifies, relates to, describes, or is otherwise associated with or can be linked with the user. In some examples, the contextual details reveal details about the user, such as their preferences, habits, and/or lifestyle. This can include a wide range of data points, such as the user's interests and hobbies (e.g., sports they play or like to watch, types of food they like, type or genres of media content they consume), the user's home and/or family life (e.g., pets the user has, a number of people in the user's household, a role the user assumes in a family or household), etc. In examples, by analyzing prior conversations 135 between the user and the chat agent 110, a comprehensive profile of the user's preferences can be built, which can then be used to generate user-tailored chat responses.

According to an aspect, the chat agent 110 includes, or is in communication with, an LM 106. In examples, the chat agent 110 leverages the LM 106 and one or more knowledge bases (e.g., a user profile data store 120 storing a user profile 125 built for the user, a conversation history data store 130 storing prior conversations 135 between the chat agent 110 and the user, and/or other data sources 140) to obtain context that assists in providing accurate and relevant chat responses to the user. In some implementations, the LM 106 is a conversational AI service model that uses ML algorithms to analyze and categorize the user's NL input into an intent and associated entities.

In other implementations, the LM 106 is embodied as a generative AI model trained to understand and generate sequences of tokens, which may be in the form of NL. The generative AI model is an ML model that can understand complex intent, cause and effect, perform language translation, semantic search classification, complex classification, text sentiment, summarization, summarization for an audience, and/or other natural language capabilities. In some examples, the generative AI model is in the form a deep neural network that utilizes a transformer architecture to process the text it receives as an input or query (e.g., in a prompt). The neural network may include an input layer, multiple hidden layers, and an output layer. The hidden layers typically include attention mechanisms that allow the generative AI model to focus on specific parts of the input text, and to generate context-aware outputs. The generative AI model is generally trained using supervised learning based on large amounts of annotated text data and learns to predict the next word or the label of a given text sequence.

The size of a generative AI model may be measured by the number of parameters it has. For instance, as one example of a large LM (LLM), the GPT-4 model from OpenAI has billions of parameters. Other possible generative AI models include BARD form Google and LLAMA from Meta, among other possible options. The parameters may be the weights in the neural network that define its behavior, and a large number of parameters allows the model to capture complex patterns in the training data.

The training process typically involves updating these weights using gradient descent algorithms, and is computationally intensive, requiring large amounts of computational resources and a considerable amount of time. The generative AI model in examples herein, however, is pre-trained, meaning that the generative AI model has already been trained on the large amount of data. This pre-training allows the model to have a strong understanding of the structure and meaning of text, which makes it more effective for the specific tasks discussed herein. In some implementations, the generative AI model is multi-modal. For instance, the generative AI model may receive inputs and/or generate outputs in different modes, such as text, images, speech, or a combination of these. In other implementations, a plurality of LMs 106 of one or various modalities are used to generate different outputs.

In example implementations, the LM 106 operates on a device located remotely from the chat agent 110. For instance, the chat agent 110 may communicate with the LM 106 using one or a combination of networks 108 (e.g., a private area network (PAN), a local area network (LAN), a wide area network (WAN)). In some examples, the LM 106 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

The user profile data store 120 is included in or communicatively connected to the chat agent 110 and stores a user profile 125 including prior conversation context. In examples, the user profile 125 is built asynchronously over time based on descriptive elements extracted from discrete prior conversations 135 with the user. A prior conversation 135 is a conversation 150 that has completed or ended, such as when the chat agent 110 is closed or when a time period has passed without receiving a subsequent chat input from the user. For instance, a prior conversation 135 is a conversation 150 included in a chat session separate from a current chat session. In an example implementation, the user profile data store 120 is an object store that stores prior conversation context as dimensions or fields of various conversation objects. In examples, recurring values (e.g., across multiple conversations 150) reflect long-term preferences of the user. Some example long-term preferences include the user's interests, habits, recurring themes, etc., in their chat inputs. For example, if a user repeatedly asks about sports, this could indicate a long-term preference for sports. As another example, information stored in a user profile 125 of a user who has engaged in prior conversations 135 where the user asks the chat agent 110 questions related to various programming languages may indicate a long-term user preference for computer programming.

In some implementations, prior conversation context is identified and extracted from a prior conversation 135 based on output from the LM 106. For instance, the chat agent 110 leverages the LM 106 to identify and extract descriptive elements (e.g., topics and/or other dimensions) of the prior conversation 135, which are stored in the user profile 125. In examples, the user profile 125 is built over time from multiple prior conversations 135. According to aspect, extraction, storage, and use of prior conversation context comply with privacy laws. Additionally, prior conversation context is used in accordance with privacy standards and protected from theft. In examples, options are provided to the user that allow the user to consent to collection of their prior conversation context and/or particular types of prior conversation context, to deletion of prior conversation context, and/or use of prior conversation context.

In some implementations, the user profile 125 is supplemented by context received from one or more other data sources 140, such as one or more applications 104, other chat agents, etc. Example context from a web browser application 104 includes the user's browsing history, such as addresses visited webpages and page information from entity extraction, favorites, open tabs, etc. As another example, context from another chat agent may include past conversations between the user and the other chat agent. In examples, when a prior conversation 135 is deleted, the user profile 125 is rebuilt to remove the prior conversation context extracted from the deleted prior conversation 135.

According to an aspect, when the chat agent 110 receives a next chat input in a subsequent conversation 150 between the user and the chat agent 110, the chat agent 110 retrieves and provides the user profile 125 and the chat input (e.g., the chat input, a portion of the chat input, or preprocessed chat input) to the LM 106 in a request, such as in a request prompt. The request prompt is processed by the LM 106, which provides a response that is received and processed by the chat agent 110 to generate a chat response for the user. In examples, the user profile 125 provides additional context to the LM 106 to generate a chat response that is tailored to the user based on the user's long-term preferences.

According to another aspect, prior conversations 135 between the user and the chat agent 110 are stored in the conversation history data store 130. In examples, the prior conversations 135 include multiple conversations occurring over an extended period of time and include granular contextual details (e.g., specific pieces of information, such as inputs/questions and outputs/responses) from individual conversations. The granular contextual details can include the user's mood in a particular conversation, the specific topic of discussion, a time and date of the conversation, and other specific information. In some examples, chat inputs and chat outputs of prior conversations 135 are represented and stored as or with corresponding embeddings. Embeddings may be vectors in a high-dimensional space. An example conversation history data store 130 includes a vector index that facilitates similarity searches by providing mechanisms to measure a distance/similarity between vectors to find nearest neighbors or retrieve a prior conversation 135 or a portion of a prior conversation 135 that matches certain similarity criteria.

In some examples, when the chat agent 110 receives chat input in a conversation 150 between the user and the chat agent 110, a search query is performed against the conversation history data store 130 to identify prior conversations 135 (or portions of prior conversations 135) that satisfy the query as being similar or related (e.g., relevant) to the received chat input of the conversation 150. The search query may be generated from the LM 106. In some examples, at least a portion of the prior conversations 135 identified as relevant to the chat input are provided to the LM 106 in a request including the chat input. Thus, a user-tailored response is generated and by the LM 106 and provided to the chat agent 110. The chat agent 110 processes and provides to the user in a chat response. In other examples, the relevant prior conversations 135 (or portions thereof) are summarized and provided to the LM 106 with the chat input in an LM request. In some examples, the summary of relevant conversation information is generated by a first LM 106 and the user-tailored response is generated by a second LM 106. In further examples, the chat agent 110 generates and provides the LM 106 a nested or chained request, where the output of one request can be used as the input of another request, creating more complex and dynamic interactions with the LM 106.

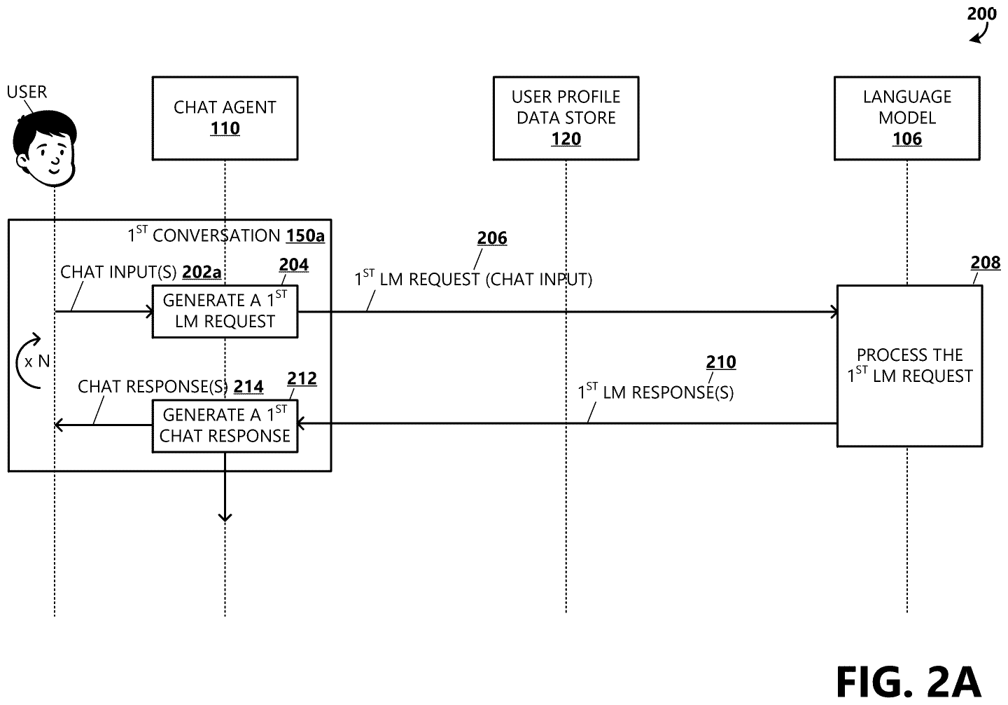

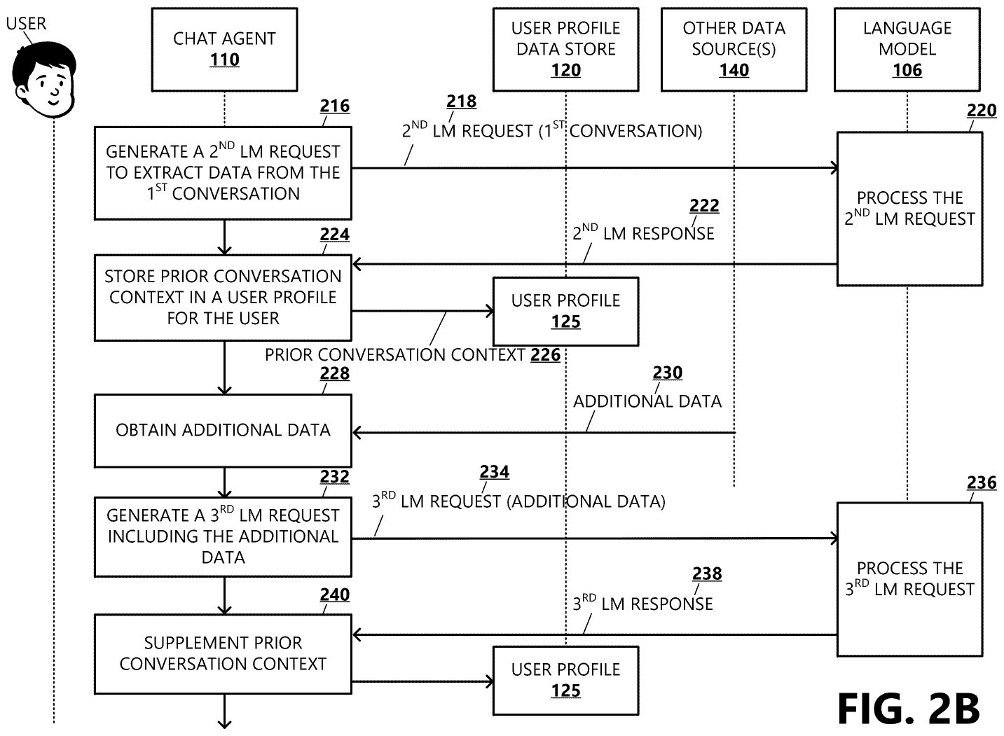

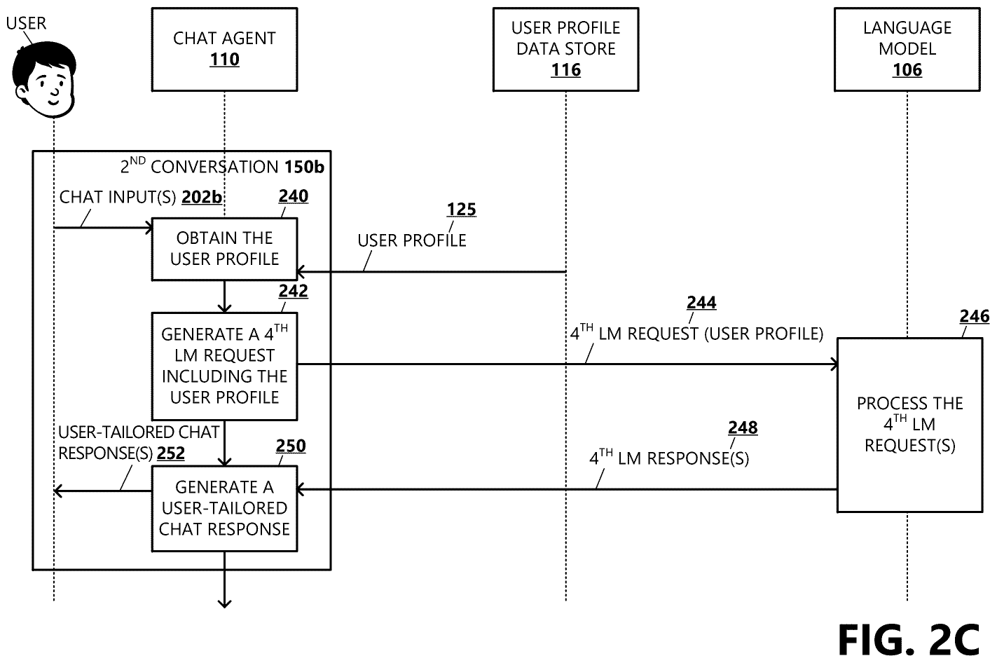

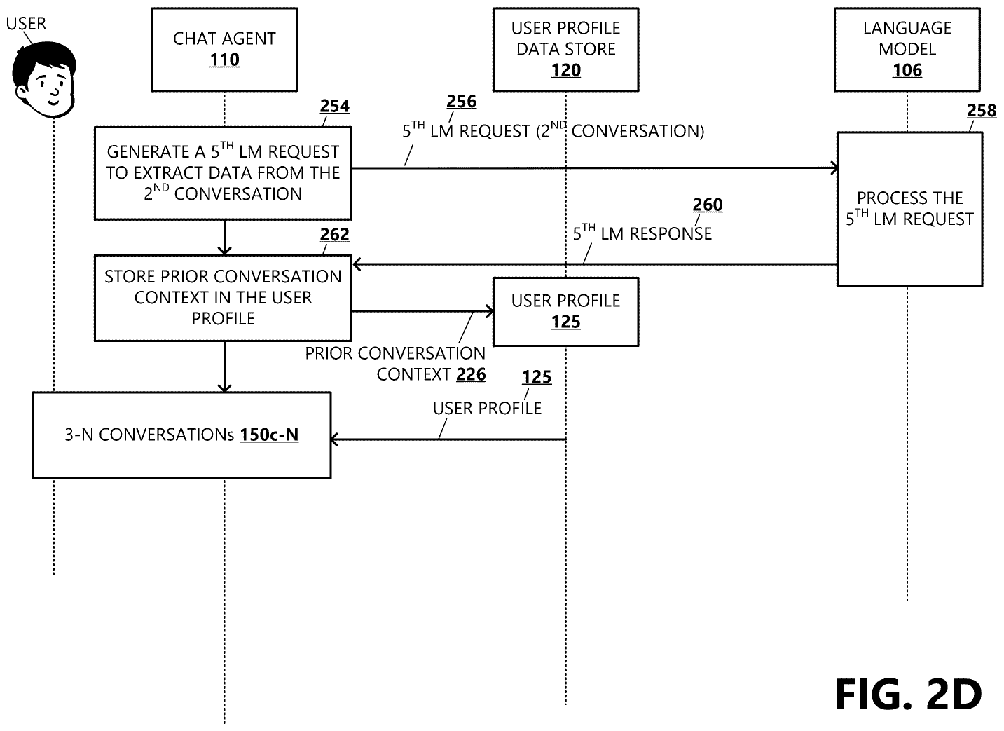

With reference now to FIGS. 2A-2D, a first data flow 200 is depicted for providing a user-tailored chat conversation 150 according to an example. As represented in FIG. 2A, a first conversation 150a includes one or more (e.g., a number (N) of) turns of back-and-forth exchanges between the user and the chat agent 110, where a chat input 202a and subsequent chat response 214 is associated with a single turn in the first conversation 150a. In some examples, upon receiving chat input 202a from the user, the chat agent 110 preprocesses the chat input 202a. When a user profile 125 has not yet been built for the user, the chat agent 110 generates (at operation 204) a first LM request 206.

In some examples, the first LM request 206 is an AI prompt that includes the chat input 202a and instructions to the LM 106 to generate a response to the chat input 202a. An AI prompt may be considered a generated set of instructions, queries, or data input that is provided as input into a generative AI model. The prompt can vary in format and encompass textual data, numerical inputs, audio cues, visual images, or any combination thereof, depending on the LM's design and functionality. The prompt initiates a computational process within the AI model, where the model applies algorithms, such as neural networks, to generate a response or output. The prompt itself may be considered a single object or closed set of data that is provided to the LM. In examples, the instructions may be in the form of a question, a statement, a scenario description, examples, or other text to guide the LM 106 to provide a desired response.

The first LM request 206 is provided to the LM 106, which processes the first LM request 206 at operation 208 and generates a first LM response 210 based on the first LM request 206. The chat agent 110 receives the first LM response 210 and, at operation 212 generates a chat response 214 based on the first LM response 210. In some examples, the chat agent 110 postprocesses the first LM response 210 to correct errors, refine the language style or tone of the response, format the response, generate selectable follow-up options, etc., before presenting the chat response 214 to the user. In examples, the first conversation 150a ends after N turns. The end of the conversation may be triggered by receiving user input to navigate away from the chat interface, explicitly end the conversation or start a new conversation, and/or a timeout period where no further interactions are received with the chat interface for the conversation. That first conversation 150a may then be stored as a discrete data item that is identifiable from other stored conversations, such as by a conversation identifier (ID).

The first data flow 200 continues to FIG. 2B, where, at operation 216, the chat agent 110 generates a second LM request 218 that instructs the LM 106 to extract data from the first conversation that can be used to build a user profile. The second LM request 218 may be in the form of another AI prompt. In examples, the second LM request 218 includes the chat inputs 202a and chat responses 214 of the first conversation 150a. Further, the second LM request 218 includes instructions to the LM 106 to extract descriptive elements (e.g., topics, keywords, phrases, other dimensions) of the prior conversation 135. In some examples, the second LM request 218 further includes one or more examples of descriptive elements and/or a desired response to guide the LM's response. The second LM request 218 may also include constraints, such as safety guidelines that instruct the LM 106 to omit extraction of certain types of sensitive information, such as financial information, medical information, etc. In other examples, the chat agent 110 or another LM extracts sensitive information prior to providing the second LM request 218 to the LM 106.

The LM 106 processes (operation 220) the second LM request 218 based on the instructions and generates a second LM response 222, which is received by the chat agent 110. In examples, the second LM response 222 includes prior conversation context 226 extracted from the first conversation 150a, which is stored by the chat agent 110 at operation 224. For instance, descriptive elements of the first conversation 150a are extracted and stored as dimensions or fields of a data object in the user's user profile 125, where recurring dimensions or fields represent long-term preferences of the user. In some examples, the chat agent 110 processes the prior conversation context 226. As an example, ML algorithms (e.g., clustering, anomaly detection, or predictive models) are used to recognize patterns or clusters within the prior conversation context 226. Thus, dimensions of prior conversation context 226 that have stable or recurring patterns (e.g., representing long-term preferences of the user) can be identified.

In some examples, operations 228-240 are additionally performed. At operation 228, the chat agent obtains additional data 230 from one or more other data sources 140, such as a web browser, another chat agent, or other applications 104. For instance, the additional data 230 may include the user's browsing history, such as addresses visited webpages and page information from entity extraction, favorites, open tabs, etc., past conversations between the user and the other chat agent, user interactions with other applications 104, etc. This additional data 230 may be based on activities that are occurring in temporally proximate manner to the conversation (e.g., the first conversation 150a). For instance, the activities may be occurring during the timeframe from the beginning of the conversation to the end of the conversation and/or a time threshold before or after the conversation.

At operation 232, the chat agent 110 generates a third LM request 234. The third LM request 234 may be another AI prompt. In examples, the third LM request 234 includes the additional data 230 and instructions to the LM 106 to extract descriptive elements (e.g., topics, keywords, or phrases) corresponding to prior conversation context 226 of the additional data 230. In some examples, the third LM request 234 further includes one or more examples of descriptive elements and/or a desired response to guide the LM's response. In further examples, the third LM request 234 includes safety guidelines to prevent extraction of certain types of sensitive information. In other examples, the chat agent 110 or another LM extracts the sensitive information prior to providing the third LM request 234 to the LM 106.

The LM 106 processes (operation 236) the third LM request 234 based on the instructions and generates a third LM response 238 including extracted context details, which is received by the chat agent 110. At operation 240, the chat agent 110 stores the received context details in the user profile 125, supplementing the prior conversation context 226. In some examples, the chat agent 110 processes the third LM response 238 prior to storing the context details.

In other examples, the second LM request 218 and the third LM request 234 may be combined as a single AI prompt to the language model 106. For example, the conversation details and the additional data may both be populated into a single AI prompt that includes instructions for the language model 106 to extract the data elements for use in populating the user profile 125.

The first data flow 200 continues to FIG. 2C, where a second conversation 150b is initiated between the user and the chat agent 110, and chat input 202b of the second conversation 150b from the user is received. At operation 240, the chat agent 110 obtains the user profile 125 for the user from the user profile data store 116. Each user profile that is stored in the user profile store 116 may include a user ID for the user to which the profile corresponds. Accordingly, obtaining or retrieving the user profile may include querying the user profile data store 116 with the user ID for the current user participating in the conversation.

At operation 242, a fourth LM request 244 is generated. The fourth LM request 244 may be in the form of an AI prompt. According to an aspect, the fourth LM request 244 includes the chat input 202b, the user profile 125 (or portions extracted therefrom), and instructions to the LM 106 to generate a response to the chat input 202b based on the user profile 125. The instructions may be in the form of a question, a statement, a scenario description, examples, conversation style description, or other text to guide the LM 106 to provide a desired response.

The fourth LM request 244 is provided to the LM 106, which processes the fourth LM request 244 at operation 246 and generates a fourth LM response 248 based on the fourth LM request 244. The user profile 125 includes prior conversation context 226 that provides the LM 106 user-related contextual details, which is used by the LM 106 to generate a response (e.g., fourth LM response 248) tailored to the user based on the user's long-term preferences. For instance, using the prior conversation context 226 in the user profile 125, the LM 106 understands and predicts the user's long-term preferences for generating the fourth LM response 248.

The chat agent 110 receives the fourth LM response 248 and, at operation 250 generates a user-tailored chat response 252 based on the fourth LM response 248. The user-tailored chat response 252, for instance, is tailored based on the user's long-term preferences. In some examples, the chat agent 110 postprocesses the fourth LM response 248 to correct errors, refine the language style or tone of the response, format the response, generate selectable follow-up options, etc., before presenting the user-tailored chat response 252 to the user. In examples, the second conversation 150b includes multiple chat inputs 202 received from the user and multiple user-tailored chat responses 252 generated and provided in response. The second conversation 150b ends after N turns.

The first data flow 200 continues further to FIG. 2D, where, at operation 254, the chat agent 110 generates a fifth LM request 256 to extract data from the second conversation for inclusion in the user profile. The fifth LM request 256 may also be in the form of an AI prompt. In examples, the fifth LM request 256 includes the chat inputs 202b and user-tailored chat responses 252 of the second conversation 150b. In examples, the fifth LM request 256 includes instructions to the LM 106 to extract descriptive elements (e.g., topics, keywords, or phrases) of the prior conversation 135. In some examples, the fifth LM request 256 further includes one or more examples of descriptive elements and/or a desired response to guide the LM's response. In further examples, the fifth LM request 256 includes safety guidelines. In other examples, the chat agent 110 or another LM extracts or removes sensitive information prior to providing the fifth LM request 256 to the LM 106. The LM 106 processes (operation 258) the fifth LM request 256 based on the instructions and generates a fifth LM response 260 including extracted prior conversation context 226, which is received by the chat agent 110. At operation 262, the chat agent 110 stores the prior conversation context 226 in the user profile 125, where recurring descriptive elements represent long-term preferences of the user. The conversation context for the second conversation may be merged with, appended to, and/or replace the data that is already present in the user profile.

In other examples, the fifth LM request includes the conversation data from all the prior conversations in the conversation store that are available for the user (or conversations within recent history, such as past week or month, etc.) For instance, in the example depicted where two conversations have recently occurred, the fifth LM request includes the conversation data from both the conversations (e.g., included in the same AI prompt). In some examples, the fifth LM request also includes any additional data associated with the conversations. Thus, when the conversation data is extracted by the LM 106 to include in the user profile, the extracted data is based on the all the conversations. In such examples, the data in the user profile may then be replaced with the conversation context that is extracted from all the conversations.

Such user profile building also allows for the user to have improved implicit control over his or her user profile. As an example, the conversations that are stored within the conversation store may be editable by the user. For instance, the user may be able to delete one or more of the prior conversations in the conversation store. When one or more of the conversations are deleted, the user profile may then be generated as an entirely new profile by reprocessing all the remaining conversations to extract the contextual data to populate the user profile. For example, after a conversation is deleted from the conversation store, an AI prompt (similar to the fifth request 256) is generated that includes the conversation details from the remaining conversations. That AI prompt is processed by the LM 106 to extract the conversation context from the remaining conversations. The extracted conversation context is then used to populate the user profile-replacing prior data of the user profile.

According to examples, the chat agent 110 uses the user profile 125 to generate and provide user-tailored chat responses 252 to received chat inputs 202 received in future conversations 150c-150N between the user and the chat agent 110.

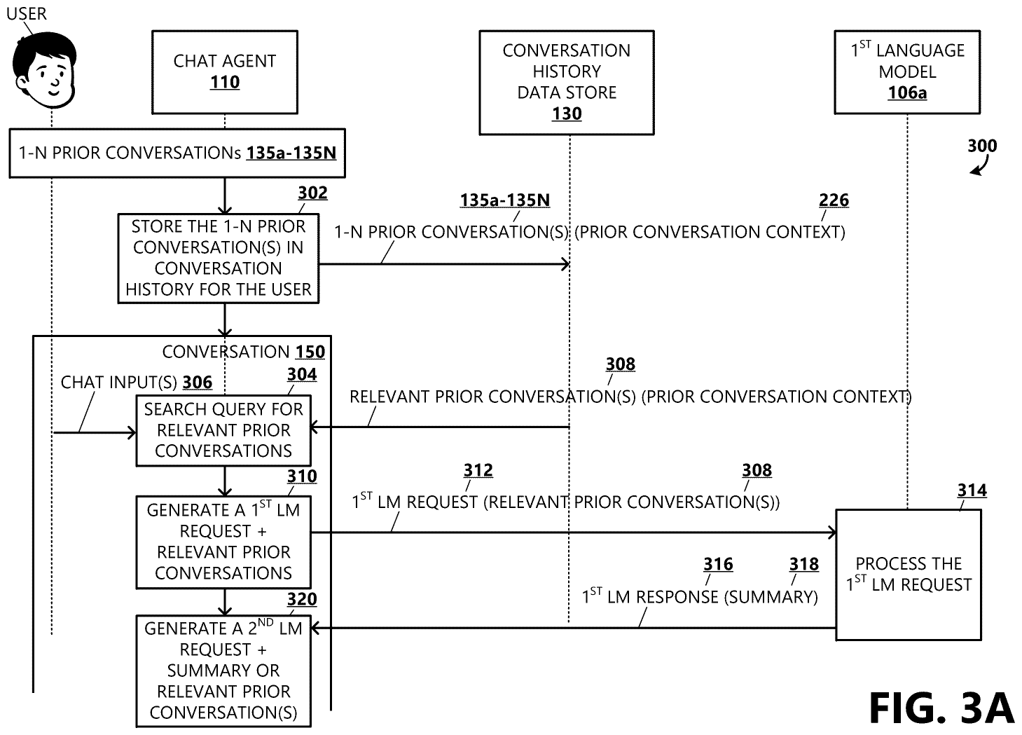

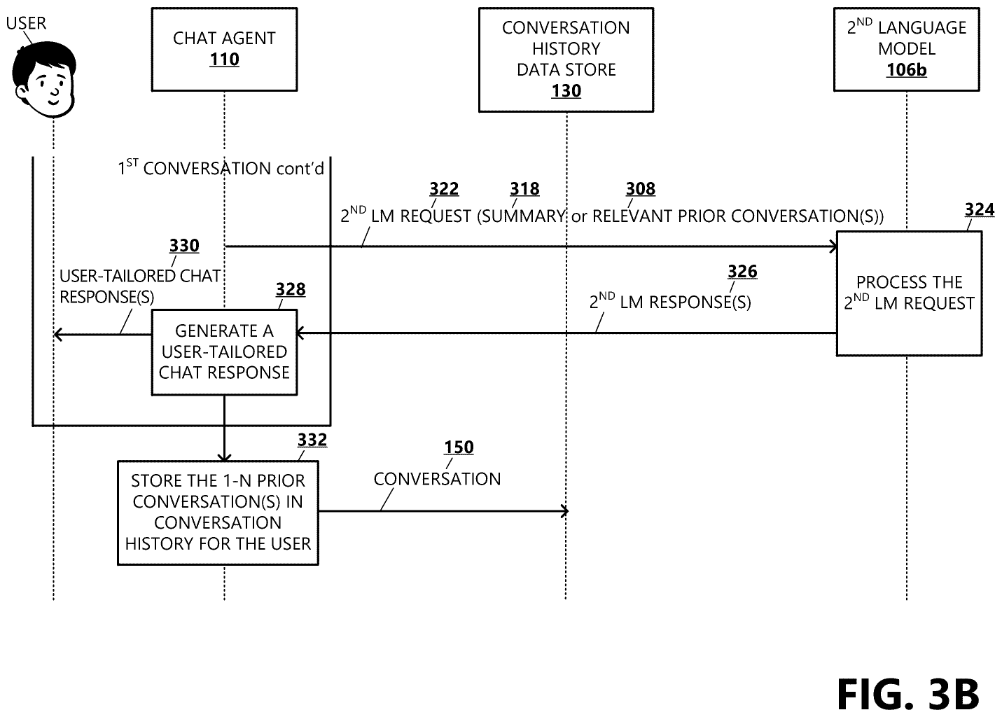

With reference now to FIGS. 3A-3B, a second data flow 300 is depicted for providing a chat conversation 150 tailored to a user according to an example. As represented in FIG. 3A, one or more independent prior conversations 135a-135N between the user and the chat agent 110 are performed (e.g., over a period of time). Each of the one or more prior conversations 135a-135N includes one or more one or more turns of back-and-forth exchanges (e.g., chat inputs 202 and chat responses 214 and/or user-tailored chat responses 252) between the user and the chat agent 110. According to an example implementation, the prior conversations 135a-135N include one or more of the conversations 150 described above with reference to FIGS. 2A-2D. At operation 302, the chat agent 110 stores conversation information (e.g., chat inputs and chat outputs) of the one or more prior conversations 135a-135N (generally, prior conversations 135) between the user and the chat agent 110 in the conversation history data store 130. In some examples, one or more of the prior conversations 135 include prior conversation context 226 that can be used to predict detailed information (e.g., granular details) for user-tailored chat responses. Each of the conversations stored in the conversation history data store 130 may have an associated conversation ID that allows for each conversation to be uniquely identified from the other conversations in the conversation history data store 130.

As depicted in FIG. 3A, a subsequent conversation 150 is initiated between the user and the chat agent 110. At operation 304, chat input 306 is received from the user. In some implementations, receiving chat input 306 from the user triggers the chat agent 110 to determine whether prior conversation context 226 would be helpful to determine a response to the chat input 306. In some examples, the chat agent 110 uses an LM 106 to make the determination. For instance, an AI prompt is generated and provided to the LM 106 that includes the chat input 306. The instructions in the AI prompt instruct the LM 106 to determine whether prior conversations would be useful context in generating a response to the chat input 306. The instructions may further instruct the LM 106 to generate a search query to identify the prior conversations that would be useful. Accordingly, the output from the LM 106 in response to such an AI prompt includes the search query that is suitable for memory retrieval of one or more relevant prior conversations 308 (e.g., one or more prior conversations 135 determined as semantically similar to the received chat input 306). The search query is then executed against the conversations for the user in the conversation history data store 130. The relevant conversations are then returned in response to the search query. In other implementations, the chat agent 110 automatically generates the search query, where the chat agent 110 processes the chat input 306 to perform a semantic search over the index of the conversation history data store 130 for relevant prior conversations 308.

In some implementations, the conversation history data store 130 includes different embeddings representing prior conversations 135 between the user and the chat agent 110. A semantic search may be performed by comparing one embedding to another, where two embeddings having similar semantic meanings may be positioned closest to one another in the multi-dimensional vector space. For instance, the chat input 306 may be transformed into an embedding (e.g., numerical vector representation). The embedding for the chat input may then be compared to the embeddings corresponding to the prior conversations or portions thereof. The embeddings that are closest to the chat-input embedding correspond to the closest, or top-scoring, prior conversations. One or more top-scoring relevant prior conversations 308 are identified based on the comparison and retrieved from the conversation history data store 130. In some implementations, a relevant portion of one or more top-scoring relevant prior conversations 308 are retrieved.

As an example, the chat input 306 may include a statement or question requesting the chat agent 110 to draw a picture of the user's dog, where contextual details about the user's dog from prior conversations 135 and/or from other data sources 140 may be determined as helpful for predicting details for drawing the picture. Thus, a search query is triggered against the conversation history data store 130 for identifying relevant prior conversations 308 determined to have relevance the chat input 306 (e.g., related to features or attributes for drawing the user's dog). Consider, for example, the user has asked questions in prior conversations 135 about traits, training recommendations for, and/or health-related issues related to a specific dog breed, activities for dogs, etc. Those prior conversations 135 (or portions of those prior conversations 135) may be determined to have semantic overlap with the chat input 306 and identified as relevant prior conversations 308 (e.g., relevant to the chat input 306 and, thus, the current conversation 150).

Operations 310 and 314 are optionally performed. In some implementations, at operation 310, a first LM request 312 is generated, where the first LM request 312 includes the one or more top-scoring relevant prior conversations 308 or relevant portions of one or more top-scoring relevant prior conversations 308 and instructions to a first LM 106a to generate a summary of the relevant prior conversations 308. The first LM request 312 may be in the form of AI prompt. The instructions may be in the form of a question, a statement, a scenario description, examples, or other text to guide the first LM 106a to provide a desired response. The first LM request 312 is provided to the first LM 106a, which processes the first LM request 312 at operation 314 and generates a first LM response 316 based on the first LM request 312. The first LM response 316 includes a summary 318 of the relevant prior conversations 308, which is provided to and received by the chat agent 110.

At operation 320, the chat agent 110 generates a second LM request 322. In some examples, the second LM request 322 includes the chat input 306 received from the user, the summary 318, and instructions to a second LM 106b to generate a response to the chat input 306 using the summary 318 (e.g., for contextual details). The second LM request 322 may be another AI prompt.

In other examples, the summaries are not generated or utilized. In such examples, the chat agent 110 generates the second LM request 322 including the chat input 306 received from the user, the one or more identified relevant prior conversations 308 retrieved from the conversation history data store 130, and instructions to the second LM 106b to generate a response to the chat input 306 using the one or more relevant prior conversations 308 for contextual details. The instructions may be in the form of a question, a statement, a scenario description, examples, conversation style description, or other text to guide the second LM 106b to provide a desired response.

In some implementations, the first LM 106a is a lighter-weight version of the second LM 106b. In other implementations, the first LM 106a and the second LM 106b are the same LM.

The second example data flow 300 continues to FIG. 3B, where the second LM request 322 is provided to the second LM 106b, which processes the second LM request 322 at operation 324 and generates a second LM response 326 based on the second LM request 322. For instance, the summary 318 and/or the relevant prior conversations 308 include prior conversation context 226 that the second LM 106b uses to generate a response (e.g., second LM response 326) that is tailored to the user. By using prior conversation context 226 from relevant prior conversations 308, the second LM 106b understands and predicts granular contextual details for generating the second LM response 326. As an example, the second LM response 326 may be a drawing of the user's dog based on details gleaned from the relevant prior conversations 308.

The chat agent 110 receives the second LM response 326 and, at operation 328, generates a user-tailored chat response 330 based on the second LM response 326. In some examples, the chat agent 110 postprocesses the second LM response 326 to correct errors, refine the language style or tone of the response, format the response, generate selectable follow-up options, etc., before presenting the user-tailored chat response 330 to the user. In examples, the conversation 150 ends after N turns. After the end of the conversation 150, the chat agent 110 stores information about the conversation 150 in the conversation history data store 130 at operation 332. For instance, the chat inputs 306 received from the user and the corresponding user-tailored chat responses 330 provided to the user, the LM requests (e.g., first LM request(s) 312 and second LM request(s) 322) sent to the one or more LMs 106, and the LM responses (e.g., first LM response(s) 316 and second LM response(s) 326) received from the one or more LMs 106 are indexed and stored in the conversation history data store 130. In other implementations, operations of the first example data flow 200 and the second example data flow 300 are combined to generate user-tailored chat responses in conversations 150 with the user based on long-term preferences represented in the user profile 125 and granular contextual details represented in relevant prior conversations 308.

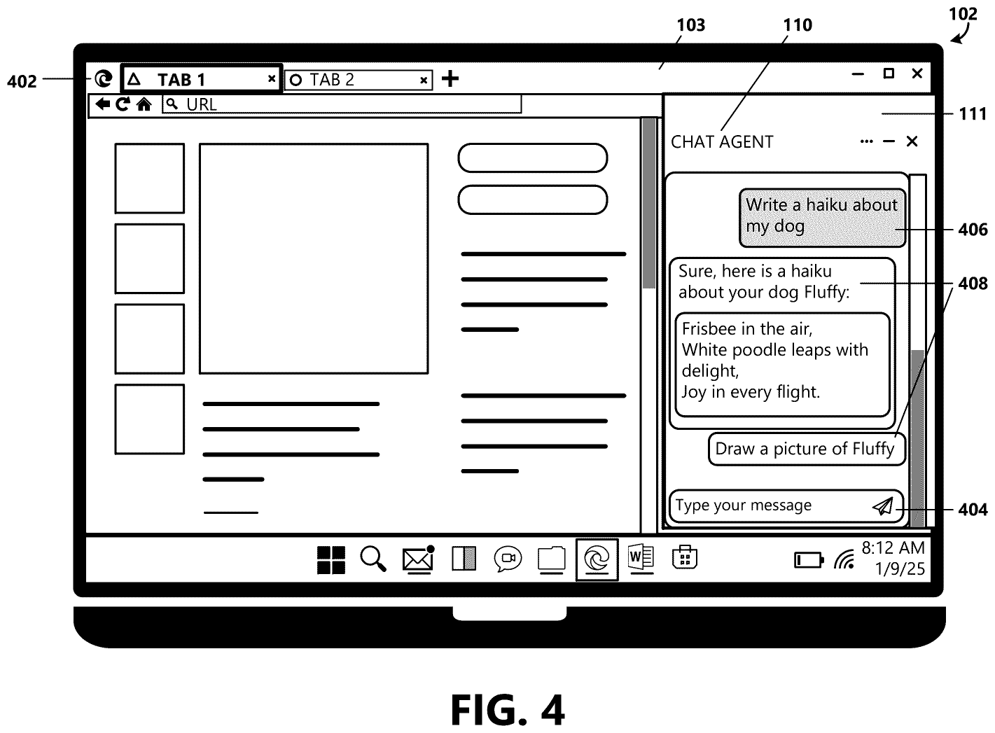

With reference now to FIG. 4, an example chat UI 111 is depicted. Although the example chat UI 111 is shown in a web browser application UI 402, in other examples, the example chat UI 111 in a different area of the display screen 103. The chat UI 111 includes an input field 404 via which the user can enter natural language chat input 406 and provide the chat input 406 to the chat agent 110. As an example, the user may input the phrase, “Write a haiku about my dog” into the input field 404. In some implementations, the chat agent 110 obtains the user profile 125 and provides prior conversation context 226 included in the user profile 125 to an LM 106 to generate a response to the chat input 406. Alternatively or additionally, the chat agent 110 performs a semantic search of the conversation history data store 130 for prior conversation context 226 in semantically relevant prior conversations 308 to the chat input 406. In some examples, identified semantically relevant prior conversations 308 are summarized (e.g., by the chat agent 110 or the LM 106). The chat input 406, relevant prior conversations 308, and/or summary of relevant prior conversations 308 are provided to the LM 106 to generate a response to the chat input 406. As an example, the LM 106 may generate a haiku about the user's dog using long-term preferences represented in the user profile 125 and/or granular contextual details obtained from semantically relevant prior conversations 308 about the user's dog, such as the dog's name, breed, color, activities, etc. The LM response is received by the chat agent 110, which generates a user-tailored chat response 408 based on the LM response and presents the user-tailored chat response 408 to the user in the chat UI 111. As an example, the user-tailored chat response 408 includes the haiku generated by the LM 106 and a selectable follow-up option (e.g., a suggested follow-up chat input).

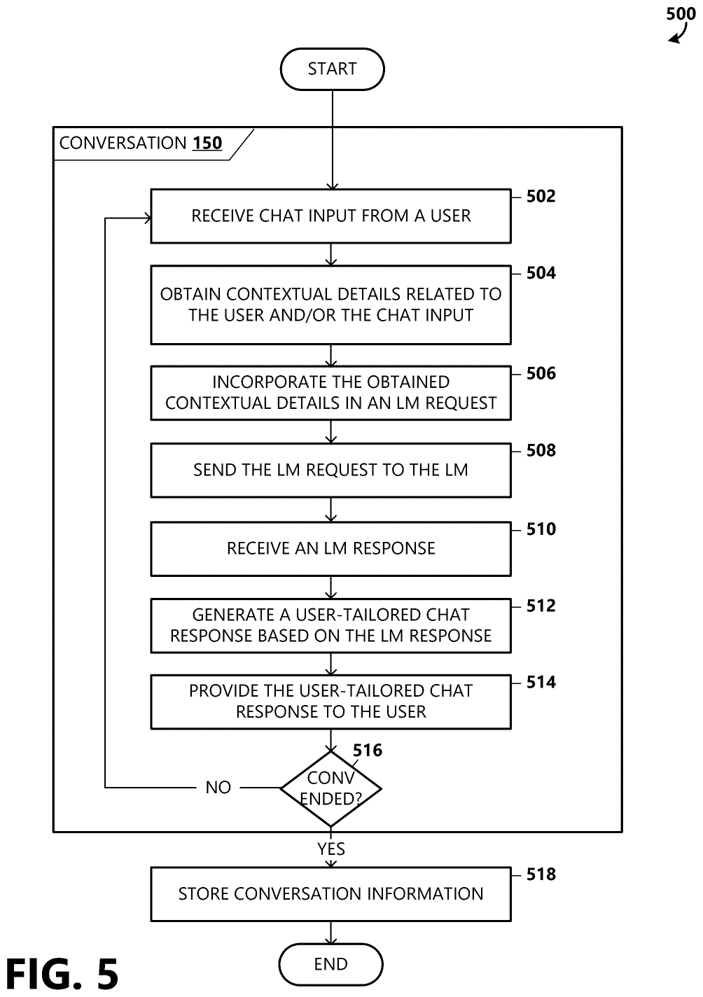

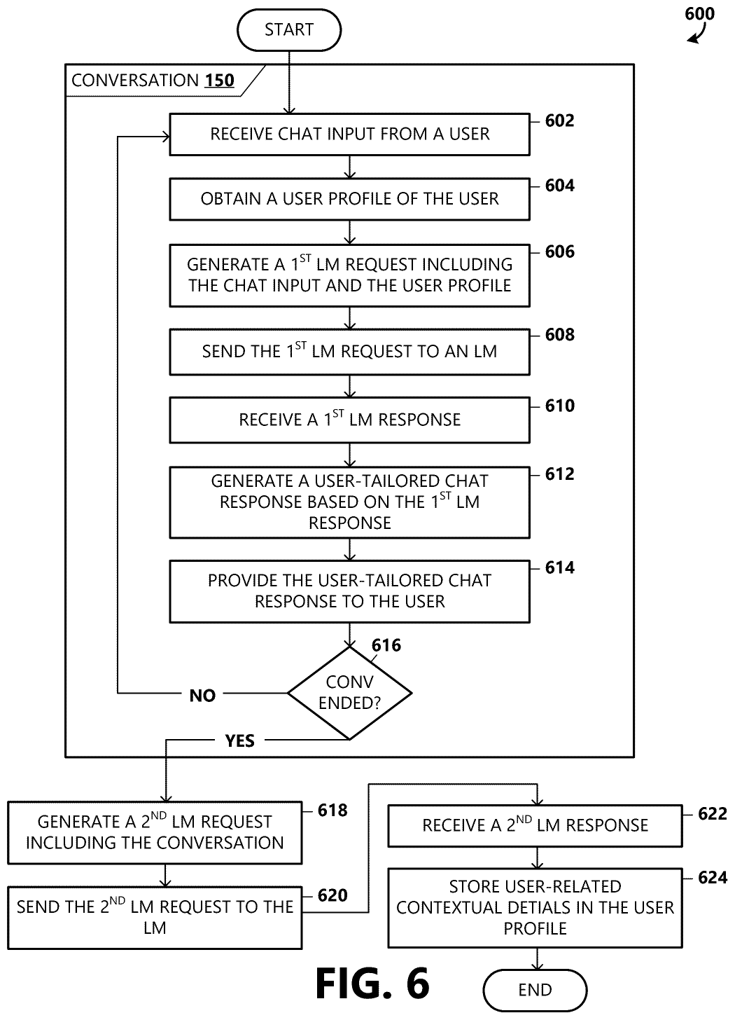

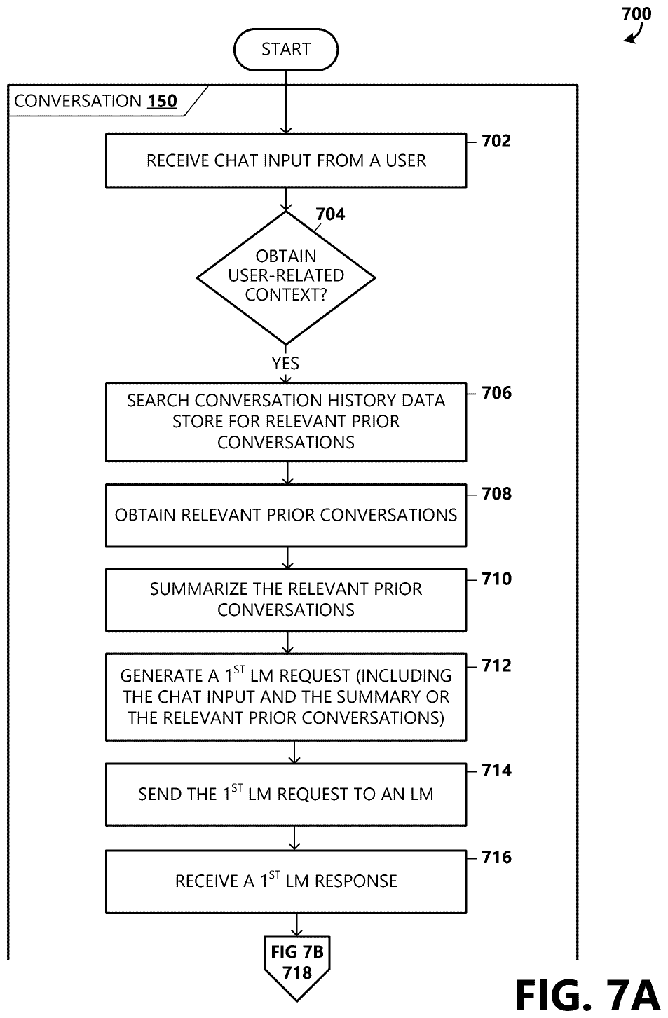

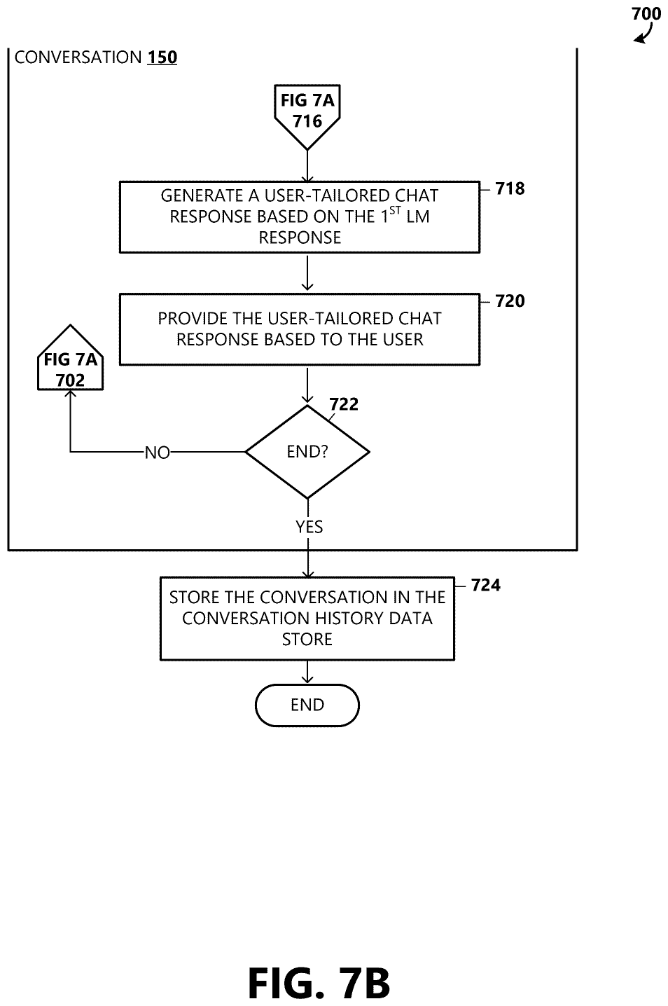

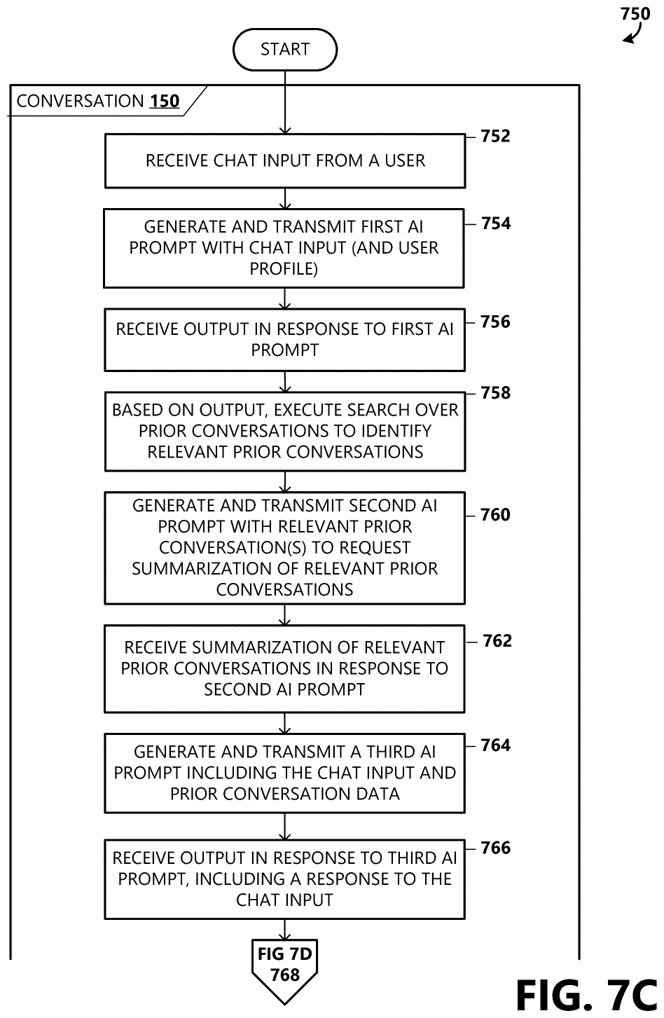

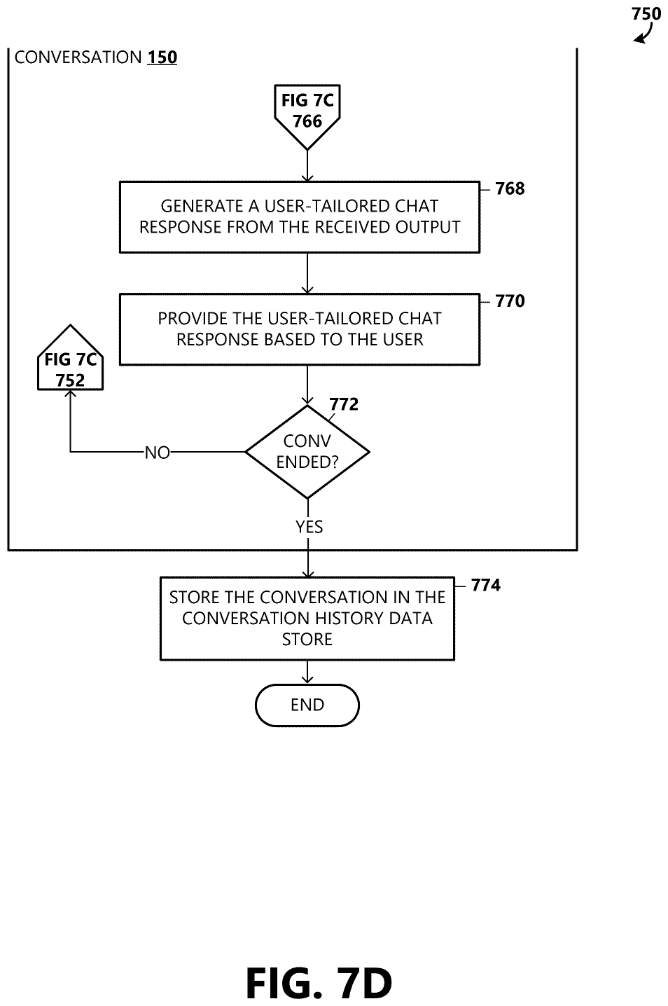

FIG. 5 depicts an example method 500 for providing a contextualized conversation. For example, the operations of method 500 are performed by the chat agent 110 to provide a response tailored to a user of a conversation 150 based on conversation history. At operation 502, natural language (chat) input is received from the user via the chat UI 111. The user may be authenticated on the user computing device 102 on which the chat agent 110 is operating, and the user may be associated with a unique user ID. At operation 504, prior conversation contextual details are obtained. In some example implementations, the chat agent 110 makes a determination as to whether prior conversation context is useful for generating a chat response to the chat input. The determination may be based on increasing quality, relevance, and/or accuracy of the response. For instance, prior conversation context may reduce ambiguity and allow the LM 106 to better understand the user's query (e.g., chat input). In other example implementations, the chat agent 110 automatically obtains prior conversation context. In some examples, and as described below in an example method 600 depicted in FIG. 6, the prior conversation context is stored in a user profile 125 for the user. In other examples, and as described below in an example method 700 depicted in FIGS. 7A and 7B, the prior conversation context is included in one or more semantically relevant prior conversations 308 stored in a conversation history data store 130. In yet other examples, contextual details are obtained from one or more other data sources 140.

At operation 506, the prior conversation context and/or contextual details obtained at operation 504 are included with the chat input in a request to the LM 106, which may be in the form of an AI prompt. For instance, the LM request further includes instructions that guide the LM 106 to use the prior conversation context to generate a response to the chat input. In some examples, the instructions include a question, statement, a scenario description, an example, conversation style description, or other text to guide the LM 106 to provide a desired response. The LM request is provided to the LM 106 at operation 508, and a corresponding LM response is received at operation 510. According to examples, the LM response is generated based on long-term preferences represented in the user profile 125 as recurring descriptive elements, granular contextual details represented in semantically relevant prior conversations 308 or a summary of semantically relevant prior conversations 308, and/or other contextual details provided by one or more other data sources 140.

At operation 512, the chat agent 110 receives the LM response and generates a user-tailored chat response based on the LM response, which is provided to the user at operation 514. In some examples, the user-tailored chat response is displayed to the user in the chat UI 111.

At decision operation 516, a determination is made as to whether the conversation 150 has ended. In some examples, the method 500 returns to operation 502, where subsequent chat input is received from the user. In other examples, the method 500 proceeds to operation 518 where, when subsequent chat input is not received within a time period or when the chat agent 110 is closed, the conversation 150 is determined to have ended. At operation 518, information about the conversation 150 is stored. For instance, the chat inputs and chat responses are stored as a prior conversation 135 in the conversation history data store 130. Additionally or alternatively, descriptive elements are extracted from the prior conversation 135 and stored in the user profile 125. The method 500 may end after operation 518.

FIG. 6 depicts an example method 600 for providing a contextualized conversation 150 with a user using prior conversation context stored in a user profile 125 for the user. For example, the operations of method 600 are performed by the chat agent 110 to provide user-tailored chat responses in the conversation 150. At operation 602, natural language chat input is received from the user via the chat UI 111. The user may be authenticated on the user computing device 102 on which the chat agent 110 is operating. At operation 604, the user profile 125 for the user is obtained from the user profile data store 120. In some examples, if a user profile 125 for the user is not included in the user profile data store 120, a new user profile 125 is created from prior conversations, stored in the prior conversation store, associated with the user. In other examples, the user profile 125 includes descriptive element dimensions of long-term (e.g., built over time) preferences and other prior conversation context 226 identified and extracted from prior conversations 135 between the user and the chat agent 110.

At operation 606, a first LM request is generated including the received chat input from the user, the user profile 125 (or portions thereof), and instructions to elicit a desired first response from an LM 106, such as a response tailored to the user based on long-term preferences represented in the user profile 125. The first LM request is provided to the LM 106 at operation 608, and a first response is received from the LM 106 at operation 610. At operation 612, the chat agent 110 generates a user-tailored chat response based on the first LM response, which is provided to the user via the chat interface 111 at operation 614.

At decision operation 616, a determination is made as to whether the conversation 150 has ended. In some examples, the method 600 returns to operation 602, where subsequent chat input is received from the user. In other examples, the method 600 proceeds to operation 618 where, when subsequent chat input is not received within a time period or when the chat agent 110 is closed, the conversation 150 is determined to have ended.

At operation 618, information from the conversation 150 (e.g., chat inputs received from the user and chat responses provided to the user) are included in a second LM request. In examples, the second LM request further includes instructions for the LM 106 to identify and extract descriptive elements from the conversation 150. At operation 620, the second LM request is provided to the LM 106 and a corresponding second LM response is received at operation 622.

At operation 624, the descriptive elements extracted from the conversation 150 and stored in the user's user profile 125. In examples, the user profile 125 is asynchronously built over time based on descriptive elements extracted from discrete prior conversations 135 with the user, where recurring descriptive elements may represent the user's long-term preferences. For instance, as discussed above, the LM request generated in operation 618 may include all the prior conversations for the user in that are stored in the conversation history store. Accordingly, the details extracted are from the available prior conversations, and populating the user profile in operation 624 accounts for the available prior conversations. The method 600 may end after operation 624. Future chat inputs may then be processed with the user profile by including the data from the user profile in an LM request along with the chat input.

FIGS. 7A and 7B depict an example method 700 for providing a contextualized conversation 150 with a user based on conversation history. For example, the operations of method 700 are performed by the chat agent 110 to provide user-tailored chat responses in the conversation 150. At operation 702, natural language chat input is received from the user via the chat UI 111. The user may be authenticated on the user computing device 102 on which the chat agent 110 is operating.

At decision operation 704, a determination is made as to whether to obtain prior conversation context for responding to the received chat input. In some implementations, an LM 106 is prompted to make the determination based on whether prior conversation context may increase quality, relevance, and/or accuracy of a response from the LM 106. In other example implementations, the chat agent 110 automatically obtains prior conversation context.

At operation 706, a semantic search is performed over an index of the conversation history data store 130 for one or more prior conversations 135 semantically similar to the received chat input. At operation 708, one or more semantically relevant prior conversations 308 are identified and are obtained by the chat agent 110. Optionally, at operation 710, the one or more relevant prior conversations 308 are summarized. In some implementations, the one or more relevant prior conversations 308 are included in a preliminary LM request with instructions to summarize the one or more relevant prior conversations 308, where a corresponding LM response is received by the chat agent 110 including a summary of the one or more relevant prior conversations 308.

At operation 712, the chat agent 110 generates a first LM request including the received chat input and the one or more relevant prior conversations 308, or optionally, the summary of the relevant prior conversations 308. In examples, the first LM request further includes instructions to elicit a desired first response from an LM 106, such as a response tailored to user based on granular details represented in the relevant prior conversations 308 or the summary of the relevant prior conversations 308. The first LM request is provided to the LM 106 at operation 714 and a first response is received from the LM 106 at operation 716. Continuing to operation 718 in FIG. 7B, the chat agent 110 generates a user-tailored chat response based on the first LM response, which is provided to the user via the chat interface 111 at operation 720.

At decision operation 722, a determination is made as to whether the conversation 150 has ended. In some examples, the method 700 returns to operation 702, where subsequent chat input is received from the user. In other examples, the method 700 proceeds to operation 724 where, when subsequent chat input is not received within a time period or when the chat agent 110 is closed, the conversation 150 is determined to have ended. At operation 724, the chat agent 110 provides the chat inputs and chat responses from the conversation 150 to the conversation history data store 130 for storage. In examples, the conversation 150 is converted into an embedding in the conversation history data store index. The method 700 may end after operation 724.

FIGS. 7C and 7D depict an example method 750 for providing a contextualized conversation 150 with a user based on conversation history. The example method 750 is substantially similar to the method 700 described above, but method 750 is discussed more specifically with reference to AI prompt generation and processing. For example, the operations of method 750 are performed by the chat agent 110 to provide user-tailored chat responses in the conversation 150.

At operation 752, a chat input is received from the user. The chat input may be a natural language input or other types of input, including multi-modal inputs. At operation 754, a first AI prompt is generated that includes the chat input and instructions that instruct the LM to generate a response to the chat input and/or determine whether generating a response to the chat input would benefit from context from prior conversations. In some examples, the first AI prompt also includes data from a user profile, as discussed above. Operation 754 may also include transmitting, or otherwise providing, the first AI prompt to the LM.

At operation 756, an output is received from the LM in response to the first AI prompt. The output includes data indicating whether prior conversations are helpful in generating a response to the chat input. Where the output indicates that prior conversations are helpful, the output may also include a search query that may be executed to identify potentially relevant prior conversations or portions thereof.

At operation 758, based on the output indicating that the prior conversations would be helpful, a search is executed over the prior the prior conversations to identify relevant prior conversations to be used as context for responding to the chat input. The search may be executed as a keyword search or other types of searches over the prior conversations stored in the conversation history data store. In some examples, the search may be executed as an embedding comparison based on an embedding for the chat input and/or the search query terms and embeddings generated for the prior conversations.

Operations 760-762 may then be optionally performed to generate summaries of the relevant prior conversations identified in operation 758. At operation 760, a second AI prompt is generated with the identified relevant prior conversations and an instruction to generate a summary for each of the identified relevant prior conversations and/or for all of the identified relevant prior conversations.

The second AI prompt is then transmitted to, or otherwise provide to, the LM. The LM processes the second AI prompt and generates an output in response to the second AI prompt. The output includes the summaries that were instructed to generate. That output is received in operation 762.

At operation 764, a third AI prompt is generated that includes the chat input, the prior conversation data, and, in some examples, the user-profile data. The prior conversation data includes the actual conversation data from the relevant prior conversations identified in operation 758 and/or the summaries of the relevant prior conversations generated in operations 760-762. The third AI prompt further includes instructions to generate a response to the chat input based on at least the chat input, the prior conversation data, and, where used, the user-profile data.

The LM processes the third AI prompt and generates an output in response to the third AI prompt. The output includes a response to the chat input, and the output is received in operation 766. At operation 768, the chat response from the output is generated, such as by extracting and/or formatting the chat response from the output. At operation 770, the chat response to surfaced in the chat interface such that is provided to the user.

At operation 772, a determination is made as to whether the conversation 150 has ended. If the conversation has ended, the conversation is stored in the conversation history data store in operation 774. If the conversation has not ended, the method 750 returns to operation 752 where the method 750 may be repeated for a next turn in the conversation 150. Operations 768-774 may be substantially similar to operations 718-724 of method 700 described above.

FIG. 8 and the associated description provide a discussion of a variety of operating environments in which examples of the invention may be practiced. However, the devices and systems illustrated and discussed with respect to FIG. 8 is for purposes of example and illustration and is not limiting of a vast number of computing device configurations that may be utilized for practicing aspects of the invention, described herein. FIG. 8 is a block diagram illustrating physical components (i.e., hardware) of a computing device 800 with which examples of the present disclosure may be practiced. The computing device components described below may be suitable for a client device running the web browser discussed above. In a basic configuration, the computing device 800 may include a processing system 802 including at least one processing unit and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for running software applications 850 (e.g., application 104 and the chat agent 110).

The operating system 805, for example, may be suitable for controlling the operation of the computing device 800. Furthermore, aspects of the invention may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing system 802, the program modules 806 may perform processes including, but not limited to, one or more of the operations of the methods and/or data flows illustrated in the Figures. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 800 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 800 may also have one or more input device(s) 812 such as a keyboard, a mouse, a pen, a sound input device, a touch input device, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As should be appreciated from the foregoing, the present technology results in multiple improvements to the technology. As one example, descriptive elements extracted from prior conversations and/or granular contextual details of prior conversations relevant to chat input received in a current conversation conserves overall usage and processing of the AI models. For instance, prior conversation context enriches the interaction between the user and the chat agent by enabling a more nuanced understanding of the user's chat input to generate relevant and tailored chat responses. As a result of processing performed on prior conversation context, accuracy of a produced output is increased, which leads to fewer reruns of the AI model requests.

In an aspect, the technology relates to a computing system for providing a contextualized response, the computing system comprising: a processing system; and memory storing instructions that, when executed by the processing system, cause the computing system to: receive chat input, from a user of a chat agent, via a chat interface; obtain prior conversation context related to the chat input, wherein the prior conversation context includes at least one of user-profile data for the user or prior conversations of the user; generate a request for a language model (LM) including: the chat input; and the obtained prior conversation context; provide the request to the LM; in response to the request, receive a response from the LM, wherein the response is tailored to the user based on the prior conversation context; generate a user-tailored chat response based on the response received from the LM; and surface the user-tailored chat response in the chat interface. In some examples, the received chat input is included in a current chat session and the prior conversations are included in at least one separate chat session. In further examples, the user profile is generated by: generating another LM request including at least one of the prior conversations, between the user and the chat agent, and instructions instructing the LM to extract data from the at least one of the prior conversations; receiving the extracted data as output from the LM; and storing the extracted data as the user-profile data in a user profile of the user. In yet further examples, the instructions further cause the computing system to: request the LM to identify a topic of the chat input and the user-tailored chat response; receive a response from the LM including the topic; and store the topic in the user profile. In still yet further examples, the chat input comprises a plurality of chat inputs; the user-tailored chat response comprises a plurality of user-tailored chat responses generated based on the plurality of chat inputs; and the topic includes at least one topic. In additional examples, the instructions further cause the computing system to execute a search query over the prior conversations to identify at least one relevant prior conversation to the chat input. In yet additional examples, the prior conversations are stored in a prior conversation store. In further additional examples, the request for the LM includes at least a prior response or a prior input of the identified at least one relevant prior conversation. In yet further additional examples, the instructions further cause the computing system to generate a summary of the at least at least one relevant prior conversation; and the request for the LM includes the summary. In still yet further additional examples, executing the search query over the prior conversations includes performing an embedding comparison between an embedding generated for at least the chat input and embeddings generated for the prior conversations. In yet further examples, the request for the LM is an artificial intelligence (AI) prompt and the LM is a generative AI model that processes the request by employing an encoder-decoder structure and self-attention mechanisms for multiple layers of a transformer-based neural network.

In another aspect, the technology relates to a computer-implemented method for generating contextualized response, comprising: accessing a plurality of prior conversations between a user and a chat agent; generating an artificial intelligence (AI) prompt including at least a portion of the plurality of prior conversations and instructions to extract data from the plurality of prior conversations; transmitting the AI prompt to a language model (LM); receiving, in response to the AI prompt, the extracted data from the plurality of prior conversations; storing the extracted data in a user profile of the user; receiving, in a first conversation, a first chat input from the user in a chat interface; obtaining the user profile including prior conversation context related to the user; generating a first request for a language model (LM) including the first chat input and the user profile; providing the first request to the LM; receiving a first response from the LM based on the first request; generating a first user-tailored chat response based on the first response from the LM; and surfacing the first user-tailored chat in the chat interface. In some examples, the computer-implemented method further comprises determining that the first conversation has ended; generating an additional AI prompt with the plurality of prior conversations, the first conversation, instructions to extract data from the plurality of prior conversations and the first conversation; transmitting the additional AI prompt to the LM; receiving, in response to the AI prompt, the extracted data from the plurality of prior conversations and the first conversation; generating an updated user profile by replacing data of the user profile with the extracted data from the plurality of prior conversations and the first conversation. In further examples, the computer-implemented method comprises receiving, in a second conversation, a second chat input from the user in the chat interface; obtaining the updated user profile; generating a second request for the LM including the second chat input and the updated user profile; providing the second request to the LM; receiving a second response from the LM based on the second request and the updated user profile; generating a second user-tailored chat response based on the second response from the LM; and surfacing the second user-tailored chat response in the chat interface. In yet further examples, the computer-implemented method comprises storing the first conversation and the second conversation as prior conversations in a conversation history data store with the plurality of prior conversations. In still yet further examples, storing the first conversation as a prior conversation comprises storing the first chat input and the user-tailored chat response as embeddings.

In another aspect, the technology relates to a computer-implemented method of providing a contextualized response, comprising: receiving chat input, from a user of a chat agent, via a chat interface; identifying at least one relevant prior conversation by executing a search of a plurality of prior conversations between the user and the chat agent; obtaining the identified relevant prior conversation; generating a first request for a language model (LM) including data based on the identified relevant prior conversation and the chat input; providing the first request to the LM; receiving a first response from the LM based on the first request; generating a user-tailored chat response based on the first response from the LM; and surfacing the user-tailored chat response to the user. In some examples, the data based on the identified relevant prior conversation is at least one chat input or response within the identified relevant prior conversation. In further examples, the computer-implemented method comprises generating a second request for a language model (LM) including the relevant prior conversation and instructions to summarize at least a portion of the relevant prior conversation; providing the second request to the LM; receiving a second response from the LM based on the first request, the second response including a summary of the relevant prior conversation, wherein the data based on the identified relevant prior conversation is the summary of the relevant prior conversation. In yet further examples, the computer-implemented method comprises generating a second request, prior to the first request, to the LM, the second request including the chat input and instructions to generate a search query for the chat input; transmitting the second request to the LM; and receiving, in response to the second request, the search query for the chat input, wherein executing the search of the plurality of prior conversations is performed with the search query.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A computing system for providing a contextualized response, the computing system comprising:
a processing system; and
memory storing instructions that, when executed by the processing system, cause the computing system to:
receive chat input, from a user of a chat agent, via a chat interface;
obtain prior conversation context related to the chat input, wherein the prior conversation context includes at least one of user-profile data for the user or prior conversations of the user;
generate a request for a language model (LM) including:
the chat input; and
the obtained prior conversation context;
provide the request to the LM;
in response to the request, receive a response from the LM, wherein the response is tailored to the user based on the prior conversation context;
generate a user-tailored chat response based on the response received from the LM; and
surface the user-tailored chat response in the chat interface.

2. The computing system of claim 1, wherein the received chat input is included in a current chat session and the prior conversations are included in at least one separate chat session.

3. The computing system of claim 1, wherein the user profile is generated by:
generating another LM request including at least one of the prior conversations, between the user and the chat agent, and instructions instructing the LM to extract data from the at least one of the prior conversations;
receiving the extracted data as output from the LM; and
storing the extracted data as the user-profile data in a user profile of the user.

4. The computing system of claim 3, wherein the instructions further cause the computing system to:
request the LM to identify a topic of the chat input and the user-tailored chat response;
receive a response from the LM including the topic; and
store the topic in the user profile.

5. The computing system of claim 4, wherein:
the chat input comprises a plurality of chat inputs;
the user-tailored chat response comprises a plurality of user-tailored chat responses generated based on the plurality of chat inputs; and
the topic includes at least one topic.

6. The computing system of claim 1, wherein the instructions further cause the computing system to execute a search query over the prior conversations to identify at least one relevant prior conversation to the chat input.

7. The computing system of claim 6, wherein the prior conversations are stored in a prior conversation store.

8. The computing system of claim 6, wherein the request for the LM includes at least a prior response or a prior input of the identified at least one relevant prior conversation.

9. The computing system of claim 6, wherein:
the instructions further cause the computing system to generate a summary of the at least at least one relevant prior conversation; and
the request for the LM includes the summary.

10. The computing system of claim 6, wherein executing the search query over the prior conversations includes performing an embedding comparison between an embedding generated for at least the chat input and embeddings generated for the prior conversations.

11. The computing system of claim 1, wherein the request for the LM is an artificial intelligence (AI) prompt and the LM is a generative AI model that processes the request by employing an encoder-decoder structure and self-attention mechanisms for multiple layers of a transformer-based neural network.

12. A computer-implemented method for generating contextualized response, comprising:
accessing a plurality of prior conversations between a user and a chat agent;
generating an artificial intelligence (AI) prompt including at least a portion of the plurality of prior conversations and instructions to extract data from the plurality of prior conversations;
transmitting the AI prompt to a language model (LM);
receiving, in response to the AI prompt, the extracted data from the plurality of prior conversations;
storing the extracted data in a user profile of the user;
receiving, in a first conversation, a first chat input from the user in a chat interface;
obtaining the user profile including prior conversation context related to the user;
generating a first request for a language model (LM) including the first chat input and the user profile;
providing the first request to the LM;
receiving a first response from the LM based on the first request;
generating a first user-tailored chat response based on the first response from the LM; and
surfacing the first user-tailored chat in the chat interface.

13. The computer-implemented method of claim 12, further comprising:
determining that the first conversation has ended;
generating an additional AI prompt with the plurality of prior conversations, the first conversation, instructions to extract data from the plurality of prior conversations and the first conversation;
transmitting the additional AI prompt to the LM;
receiving, in response to the AI prompt, the extracted data from the plurality of prior conversations and the first conversation;
generating an updated user profile by replacing data of the user profile with the extracted data from the plurality of prior conversations and the first conversation.

14. The computer-implemented method of claim 13, further comprising:
receiving, in a second conversation, a second chat input from the user in the chat interface;
obtaining the updated user profile;
generating a second request for the LM including the second chat input and the updated user profile;
providing the second request to the LM;
receiving a second response from the LM based on the second request and the updated user profile;
generating a second user-tailored chat response based on the second response from the LM; and
surfacing the second user-tailored chat response in the chat interface.

15. The computer-implemented method of claim 14, further comprising storing the first conversation and the second conversation as prior conversations in a conversation history data store with the plurality of prior conversations.

16. The computer-implemented method of claim 15, wherein storing the first conversation as a prior conversation comprises storing the first chat input and the user-tailored chat response as embeddings.

17. A computer-implemented method of providing a contextualized response, comprising:
receiving chat input, from a user of a chat agent, via a chat interface;
identifying at least one relevant prior conversation by executing a search of a plurality of prior conversations between the user and the chat agent;
obtaining the identified relevant prior conversation;
generating a first request for a language model (LM) including data based on the identified relevant prior conversation and the chat input;
providing the first request to the LM;
receiving a first response from the LM based on the first request;
generating a user-tailored chat response based on the first response from the LM; and
surfacing the user-tailored chat response to the user.

18. The computer-implemented method of claim 17, wherein the data based on the identified relevant prior conversation is at least one chat input or response within the identified relevant prior conversation.

19. The computer-implemented method of claim 17, further comprising:
generating a second request for a language model (LM) including the relevant prior conversation and instructions to summarize at least a portion of the relevant prior conversation;
providing the second request to the LM;
receiving a second response from the LM based on the first request, the second response including a summary of the relevant prior conversation, wherein the data based on the identified relevant prior conversation is the summary of the relevant prior conversation.

20. The computer-implemented method of claim 17, further comprising:
generating a second request, prior to the first request, to the LM, the second request including the chat input and instructions to generate a search query for the chat input;
transmitting the second request to the LM; and
receiving, in response to the second request, the search query for the chat input, wherein executing the search of the plurality of prior conversations is performed with the search query.
